(19) United States
(12) Patent Application Publication
(10) Pub. No.: US 2005/0217636 A1
(43) Pub. Date: Oct. 6, 2005

(54) Toric pulsating continuous combustion rotary engine compressor or pump

(76) Inventor: Mars Sterling Turner, North Highlands, CA (US)

Correspondence Address: Mars Turner, 3706 Lowry Dr., North Highlands, CA, 95660, US

(21) Appl. No.: 10/818,864

(22) Filed: Apr. 6, 2004

(51) Int. Cl. F02B 53/00; F01C 1/00

(52) U.S. Cl. 123/245; 418/35; 418/36; 418/37; 418/38

(57) ABSTRACT

This invention leaves the paradigm of complex gears and eccentric rotor and internal housing contours found in most rotary engines. This invention improves the oscillatory rotating engine by providing the concept of continuous flow through at least one port. Made for zero eccentric friction, vibration, oil, and cooling requirements. The device incorporates few moving parts and does not need a crankshaft or a flywheel. All ports are radial or axial and have no valve, check valve, or obstruction. This invention can maintain a true continuous combustion without transfer ports.

### CROSS REFERENCE TO RELATED APPLICATIONS

There are no related applications.

### STATEMENT REGARDING FED SPONSERED R&D

There is no Fed sponsored R&D.

### TECHNICAL FIELD

This invention generally pertains to an internal or external combustion or expansion engines, pumps or compressors for use in numerous applications, including motor vehicles. More specifically it pertains to engines of the oscillatory rotating type.

### BACKGROUND OF THE INVENTION

A popular rotary piston engine is the oscillatory rotating arrangement which employs a plural number of rotors with interleaving vanes around the center of rotating. By changing the angular velocity of the rotors an oscillatory movement is superimposed on their uniform rotation, thus modifying the volume of the energy chambers defined by each pair of adjacent vanes and the inner surface of the engine housing.

Analysis of the Oscillatory Rotating Engine or ORE; The number of vanes on each rotor (being equal) is equal to the number of contraction and expansion regions of the housing. As each chamber goes through an expulsion stroke it travels or rotates through the spacing between the expulsion port and the intake port. In the spacing the chamber experiences conditions which produce a sort of short non-actuation period where it can neither expand nor contract. The two rotors defining the actuation of the chamber translates these non-actuation characteristics to all chambers exclusively defined by the two rotors. In all cases the number of chambers that experience non-continuous actuation as each chamber passes the port spacing is equal to the number of individual vanes on each rotor.

There are many prior art inventions of the two rotor combustion ORE (U.S. Pat. No. 6,293,775 et al). The design particulars of prior art two rotor ORE involve scissor action where all alternate chambers actuate diametrically opposed strokes. The non-actuation period of the two rotors makes all chambers stop actuating for a time between every single stoke, producing coupling harmonics that require robust and sophisticated gears and flywheels. Continuous combustion cannot be achieved without transfer ports.

There is one prior art three rotor expansion ORE (U.S. Pat. No. 3,744,938). The design particulars of the prior art three rotor expansion ORE involve blockage of the ports; as each vane passes it closes the ports in turn. High frequency opening and closing ports of high pressure vapor would produce large shock wave harmonics, making vibration tolerance a major limiting factor for power density.

It is therefore a principal object of this invention to provide an improved oscillatory rotating engine.

It will be appreciated by those of ordinary skill in the art that this invention has applications and embodiments not only for engines but also for pumps and compressors, even though an engine will be referred to and used throughout this specification.

### BRIEF SUMMARY OF THE INVENTION

The invention discloses a novel type of the oscillatory rotating engine utilizing at least one port that is never blocked off by passing vanes, has at least one chamber actuating continuous contraction or expansion at all times within the port region, and therefore continuous flow through it.

Embodied as an expansion engine with a continuous intake flow and or continuous exhaust flow, power density can be increased do to decreased intake and or exhaust flow harmonics. Embodied as an internal combustion engine with continuous intake flow, continuous combustion is made possible because the intake stroke and the combustion stroke are both expansion actuation and therefore behave the same way giving at least one chamber expanding in combustion at all times. Because this invention can utilize continuous combustion and continuous port flow actuation, mechanical coupling harmonics are reduced. The need for sophisticated gears and flywheels are eliminated.

Embodiments of the Brayton cycle would have continuous flow through the compression expulsion ports and expansion intake ports. The Brayton cycle can be achieved using only one ORE or there can be more then one used in series. Without this inventions novel continuous flow through the ports the Brayton cycle would not be possible for an ORE or at least realistic. Continuous compression expulsion flow is equally as important as continuous intake expansion flow to prevent combustion harmonics from reducing the possible power density due to vibration tolerance.

This invention also includes a novel vane geometry and associated housing contour of circular radial cross-section for the oscillatory rotating engine which increases sealing and sliding efficiency.

### BRIEF DESCRIPTION OF THE DRAWINGS

Other objects, features and advantages of the present invention will become more apparent upon study of the following detailed description, taken in conjunction with the drawings in which:

FIG. 1 is an exploded view of an embodiment of an engine contemplated by this invention;

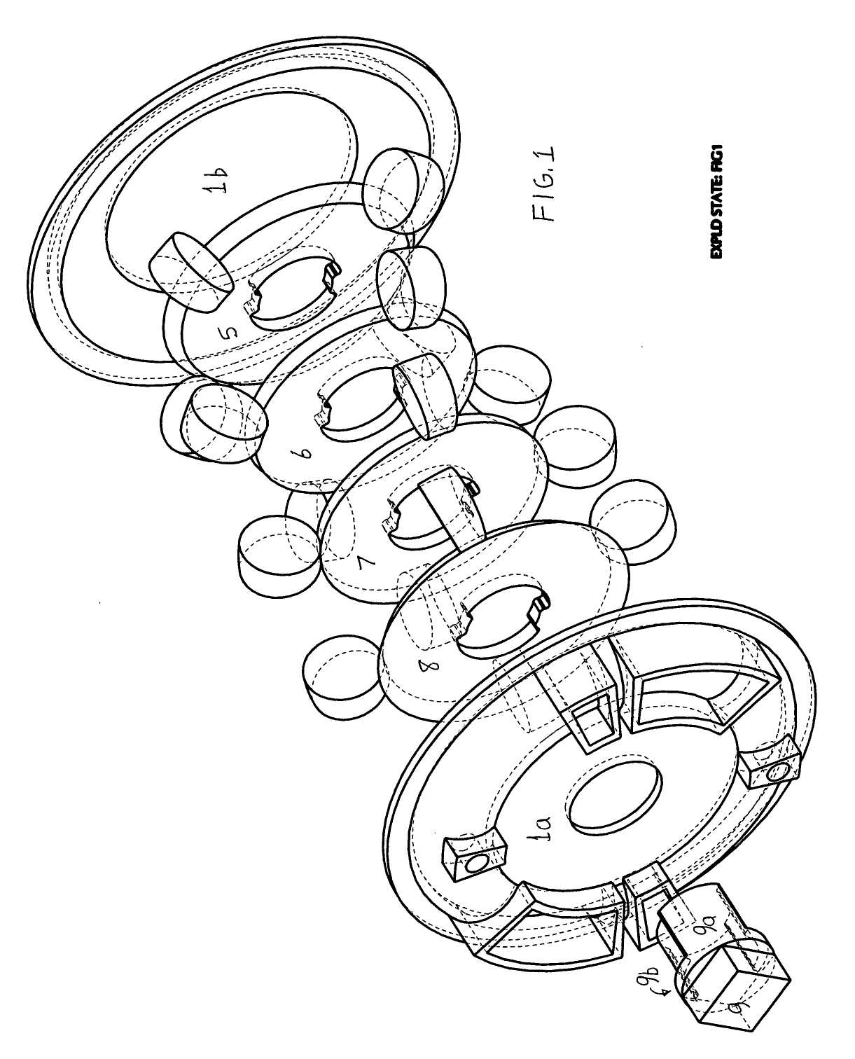

FIG. 2 is a detailed exploded view of the rotors of the engine of FIG. 1;

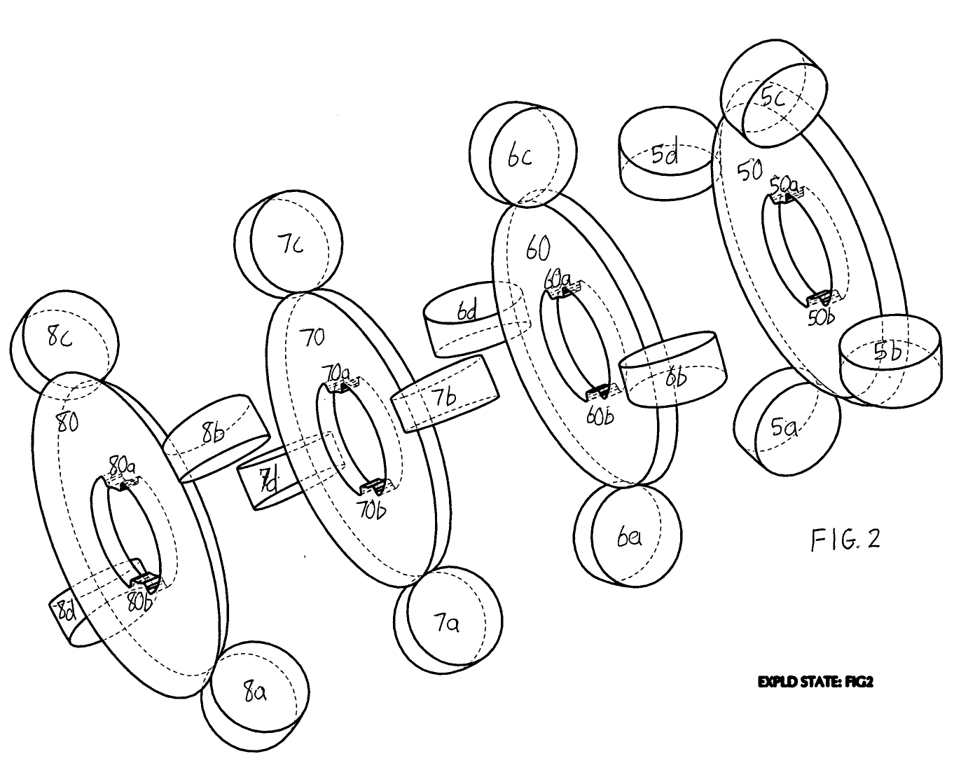

FIG. 3 is a perspective view showing the assembly of the rotors and shaft of the engine of FIG. 1;

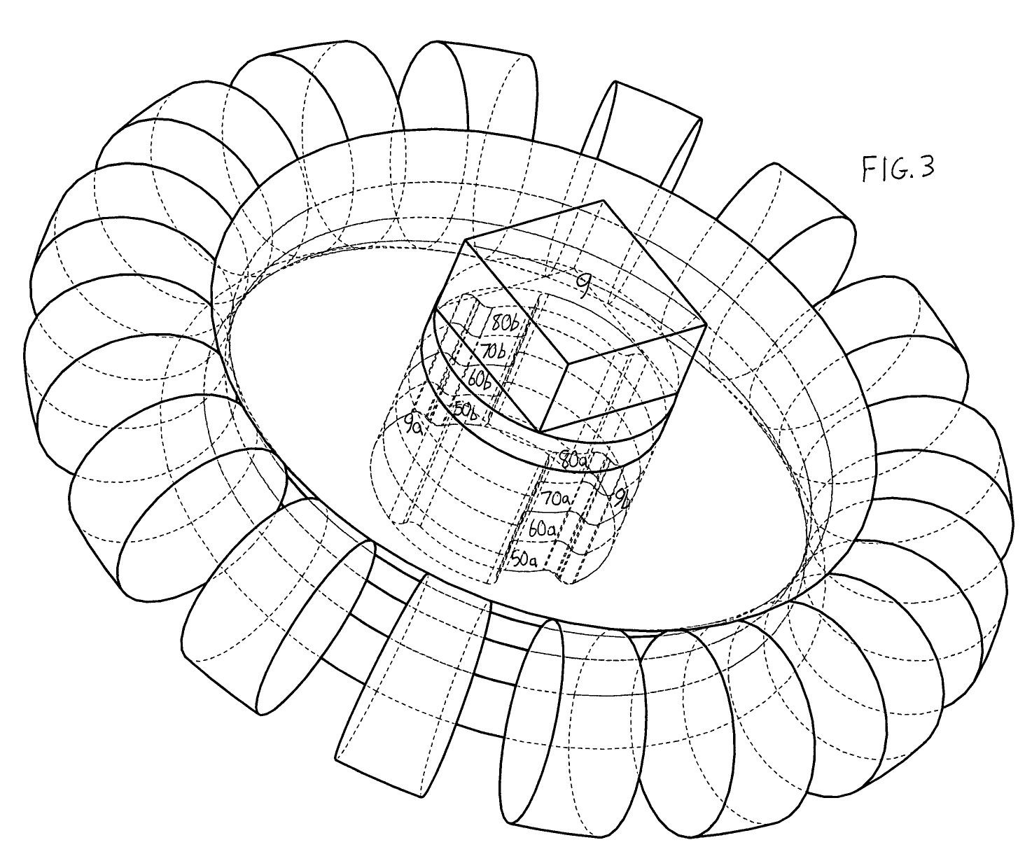

FIG. 4 is a lateral view showing rotor actuation and inner hub extrusion deviation of the engine of FIG. 1;

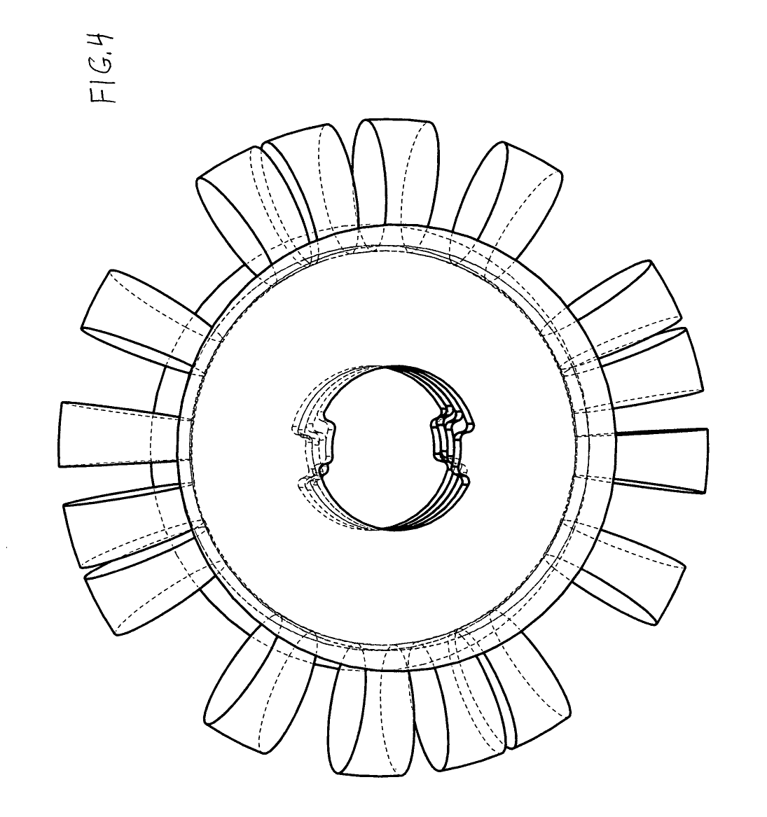

FIG. 5 is a lateral view with the same rotor actuation of FIG. 4 added with the assembled housing of the engine of FIG. 1;

FIG. 6 is a complete assembled lateral view with the same rotor actuation of FIGS. 4 & 5 of the engine of FIG. 1;

### DETAILED DESCRIPTION

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

As already noted above, the present invention relates to oscillatory rotating internal or external combustion or expansion engines, pumps or compressors. An embodiment of a internal combustion engine is here described; a housing 1a, 1b, with a toroid internal contour substantially circular in radial cross-section, two sets of ports for intakes 2a, 2b, ignitions 3a, 3b, and exhausts 4a, 4b; Four rotors 5, 6, 7, 8, each have four radial vanes 5a, 5b, 5c, 5d, 6a, 6b, 6c, 6d, 7a, 7b, 7c, 7d, 8a, 8b, 8c, 8d, substantially circular in radial cross-section; connected by central hubs 50, 60, 70, 80. Central hubs have inner opposed extrusions 50a, 50b, 60a, 60b, 70a, 70b, 80a, 80b, for mechanical coupling with the central shaft 9 by means of the shafts outer opposed extrusions 9a, 9b.

The major operational characteristics can be varied by the spacing between the ports and the size of the ports in relation to the size of the vanes.

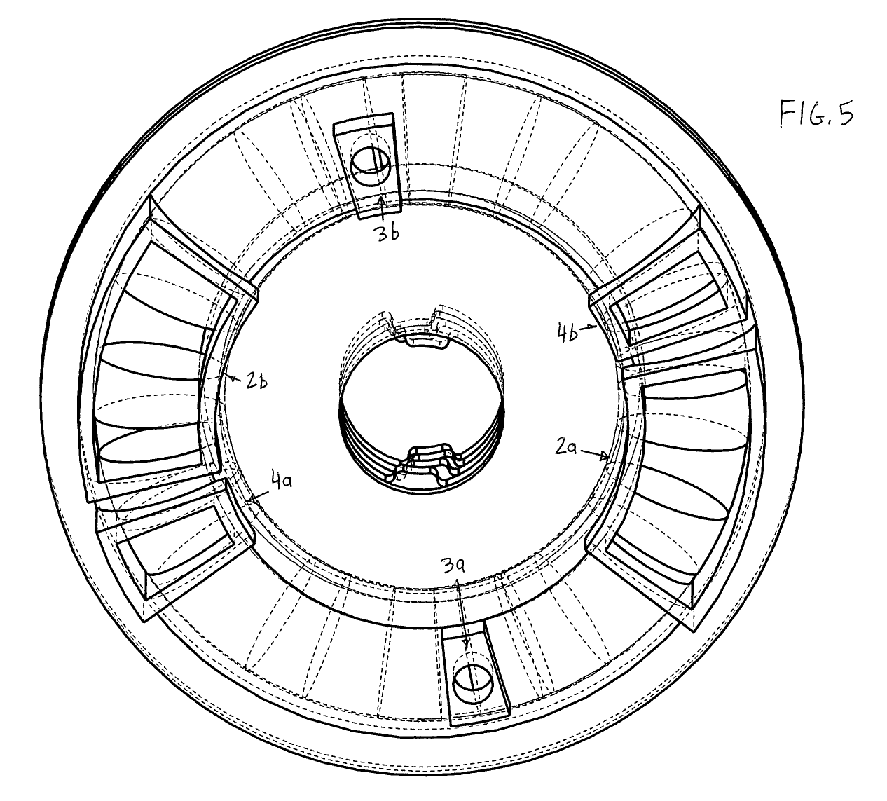

The illustrated embodiment has two chambers in continuous expansion actuation within the intake port regions at all times as noted in FIGS. 5 & 6. It also has two chambers in continuous expansion actuation within the combustion region at all times. By modifying the relative size of the intake and exhaust ports it is possible to have one chamber in continuous expansion actuation at all times within intake port regions and the combustion regions and also have one chamber in continuous contraction actuation within the exhaust port regions and compression regions at all times. It is also possible to switch the direction of the engines rotation or switching the ports were two chambers at all times would be in continuous contraction within the exhaust port regions and compression regions at all times. Though that would not be a preferred arrangement. In fact it would no longer be a continuous combustion engine and would therefore be prone to similar mechanical coupling problems faced by the prior art not to mention the other poor design characteristics it would produce.

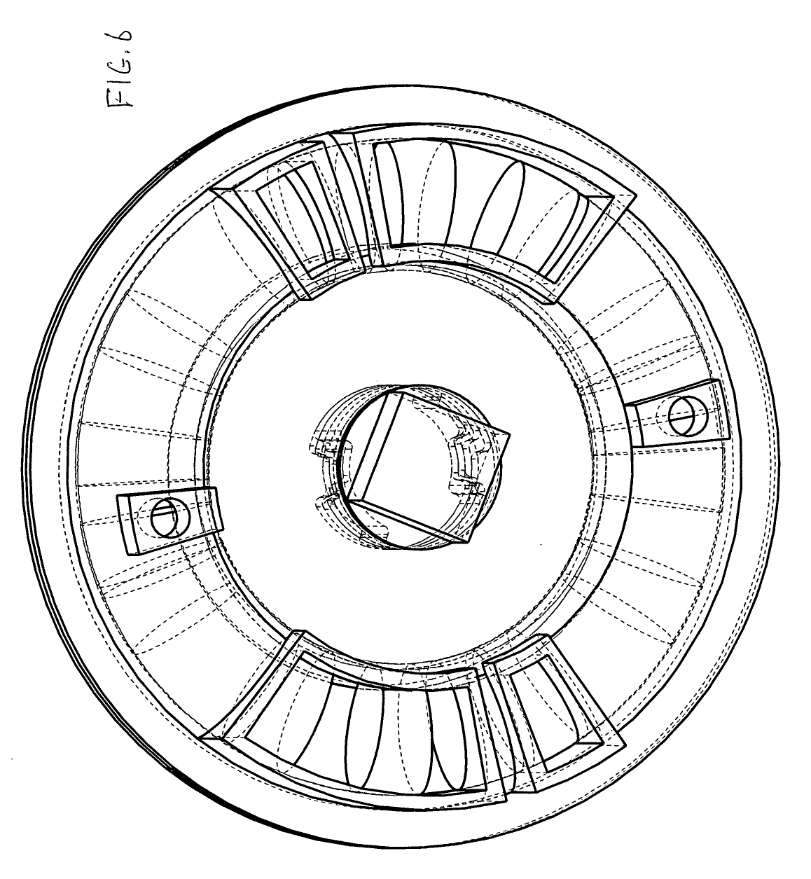

It should be noted that while central hubs and central shaft modules are identified, used and preferred in the embodiment of the invention illustrated, they are not necessary to practice the invention. There are several ways to couple a shaft to the rotors. For uniform motion of expansion to contraction and contraction to expansion a very simple coupling mechanism will do. The illustrated coupling mechanism of central hub inner extrusions to the shaft outer extrusions is an example that can be used for uniform motion where each rotor takes turns coupling to the shaft. As FIG. 6 illustrates. In cases of non-uniform motion a spring loaded coupling mechanism could be used to average the velocities of the rotors to the shaft. Or one directional gearing can be used to spin the shaft so that the shaft couples to the rotors with the highest angular velocity making the shaft output RPM higher then the average RPM of the engine. In any case all embodiments can utilize very simple and relatively small coupling mechanisms compared to prior art. Other ways to mechanically couple the rotors to a shaft are for example; an embodiment of the invention can have central hub through bores for each rotor. The embodiment assembled together where the through bores of each consecutive rotor fit into each other and extent through one or both sides of the housing. A shaft can be mechanically coupled to the through bores in a similar way as the embodiment of the invention illustrated couples to the central hubs or it can be linked together by chains and or directional gearing.

There are other ways to connect the radial vanes to form a rotor. For example; an embodiment of the invention can have lateral through bores, another could utilize outer hubs or both.

As will be appreciated by those of reasonable skill in the art, there are numerous embodiments to this invention, and variations of elements and components which may be used, all within the scope of this invention.

With this invention the internal combustion ORE receives an important upgrade to continuous combustion.

The illustrated embodiment of the present invention has 16 chambers. When each chamber goes into the spacings between the exhaust ports and the intake ports 4 chambers stop actuating. This leaves the embodiment with 12 continuous actuation chambers. Compared to all prior art internal combustion ORE's where there are zero continuous actuation chambers no matter how many vanes they add. There are multiple benefits such as an increase in fluidity of movement and magnitudes reduction in mechanical harmonics and tolerance requirements in shaft coupling. Other internal combustion benefits are made possible such as longer combustion stokes, shorter compression strokes, higher combustion efficiency, reduced sealing demands and higher power density.

FIG. 5 is a lateral view of an embodiment of an engine contemplated by this invention showing that when there is equal chamber spacing the inner hub extrusions are aligned. In full operational actuation of the engine the shaft is mechanically coupled to the rotor with the greatest angular deviance by the hub extrusions as illustrated by FIG. 6. Start of the engine can be prepared by spinning the shaft which causes continued coupling of the deviant rotors causing all the hub extrusions to line up and couple to the shaft and equally space the chambers. Once again this is not necessary for the practice of the invention it is only one way of putting the invention to use. It will be appreciated by those of ordinary skill in the art that the basic components of this engine, pump or compressor may be adapted for use with bio-fuels such as vegetable oil, methyl esters, ethanol, methanol, methane and hydrogen.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A rotary engine, pump or compressor, comprising;
A housing;
At least two rotors mounted for pulsating, rotary movement therein, each comprising:
At least two radial opposed piston means connected by at least one hub:
Wherein the rotors are assembled together configuring there piston means alternately within the housing.
Wherein the rotors oscillate relative to each other and provide sealed sliding motion to constitute said pulsating rotary movement within the internal contour of the housing.
Wherein all consecutive compressions occur repetitively in the same opposed housing areas and all consecutive expansions occur repetitively in the same alternate as well opposed intermediate housing areas;
Wherein successive compression strokes and expansion strokes start and end simultaneously;

2. A rotary engine, pump or compressor of claim 1, wherein the internal contour of the housing is substantially toroid and each of the associated piston means is correspondingly part-toroidal for sliding therein.

3. A rotary engine, pump or compressor of claim 2, wherein the internal contour of the housing and associated piston means are substantially circular in radial cross-section.

4. A rotary engine, pump or compressor of claim 2, wherein the internal contour of the housing and associated piston means are substantially half circular in radial cross-section.

5. A rotary engine, pump or compressor of claim 2, wherein the internal contour of the housing and associated piston means are substantially square in radial cross-section.

6. A rotary engine, pump or compressor of claim 1, wherein there are two rotors.

7. A rotary engine, pump or compressor of claim 1, wherein there are three rotors.

8. A rotary engine, pump or compressor of claim 1, wherein there are four rotors.

9. A rotary engine, pump or compressor of claim 1, wherein there are five rotors.

10. A rotary engine, pump or compressor of claim 1, wherein there are six rotors.

11. A rotary engine, pump or compressor of claim 1, wherein there are seven rotors.

12. A rotary engine, pump or compressor of claim 1, wherein there are eight rotors.

13. A rotary engine, pump or compressor of claim 1, wherein each rotor has two radial opposed piston means.

14. A rotary engine, pump or compressor of claim 1, wherein each rotor has four radial opposed piston means.

15. A rotary engine, pump or compressor of claim 1, wherein each rotor has six radial opposed piston means.

16. A rotary engine, pump or compressor of claim 1, wherein each rotor has eight radial opposed piston means.

17. A rotary engine, pump or compressor of claim 1, comprising:
Central hubs and a central shaft coaxial with the central housing axis;
Wherein each hubs inner radial opposed extrusions insert and link with the shafts outer radial opposed extrusions.
Wherein the hubs oscillate relative to the shaft and provide sliding coupling motion.
Wherein the shaft gives full power takeoff;

18. A rotary engine, pump or compressor of claim 1, comprising:
Central hub through bores and a central shaft coaxial with the central housing axis;
Wherein each hub through bores outer radial opposed extrusions insert and link with the shafts inner radial opposed extrusions.
Wherein the shaft gives full power takeoff;

19. A rotary engine, pump or compressor of claim 1, having radial housing ports for intakes, ignitions and exhausts.

20. A rotary engine, pump or compressor of claim 1, having axial housing ports for intakes, ignitions and exhausts.
